(19) United States
(12) Patent Application Publication
(10) Pub. No.: US 2026/0145700 A1
(43) Pub. Date: May 28, 2026

(54) DESIGN OF LOCAL LONGITUDINAL/LATERAL PLANNING AND VEHICLE TRACKING CONTROL SYSTEM CONSIDERING TOTAL PATH OF AUTONOMOUS VEHICLE

(71) Applicant: SUM Inc., Gyeonggi-do (KR)

(72) Inventors: Young Jin HYUN, Gyeonggi-do (KR); Dae Hyuck PARK, Daejeon (KR); Ji Hyoung KIM, Gyeonggi-do (KR); Jeong Goo SEO, Gyeonggi-do (KR); Hyun Sung LEE, Gyeonggi-do (KR); Jong Cherl PARK, Gyeonggi-do (KR); Jong Seo LEE, Gyeonggi-do (KR)

(21) Appl. No.: 18/958,506

(22) Filed: Nov. 25, 2024

(51) Int. Cl. B60W 60/00

(52) U.S. Cl. CPC B60W 60/001; B60W 2540/10; B60W 2540/12; B60W 2540/18; B60W 2556/50

(57) ABSTRACT

Proposed is an autonomous driving control method using an autonomous driving control system installed inside a vehicle and controlling the vehicle over an internal communication control network of the vehicle, the autonomous driving control method including (A) receiving a destination and generating a path plan, (B) measuring a position and a heading angle of the vehicle at a current time point when the vehicle is travelling, (C) calculating a target position and a target heading angle of the vehicle at the current time point, (D) calculating a longitudinal error, a lateral error, and a heading angle error at the current time point, (E) calculating a required linear velocity and a required angular velocity of the vehicle that are required, and (F) controlling an acceleration pedal (or a brake) and a steering wheel of the vehicle.

### BACKGROUND OF THE INVENTION

### Field of the Invention

The present disclosure relates to an autonomous driving control method of a vehicle, the method combining path planning and path tracking.

### Description of the Related Art

Unless otherwise indicated herein, contents set forth in this section are neither the related art to the claims of the present application, nor construed as the related art despite the inclusion in this section.

A motor vehicle is a means of transport that allows a driver to travel on the road by manipulating a steering wheel, which is a steering manipulation means, and an acceleration pedal and a brake pedal, which are an acceleration and deceleration manipulation means, and helps the vehicle driver and his or her passengers to reach a desired destination. In recent years, there has been continuous research on an autonomous driving motor vehicle in which a conventional motor vehicle equipped with a plurality of sensors and a steering control means and an acceleration and deceleration control means travels autonomously to a set destination without a driver's driving operations by identifying road states, positions of nearby vehicles and objects, and road signals.

However, in general, a conventional autonomous driving control method performs control by comparing only the path at the current time point and the state of the vehicle without considering the total path, and handles longitudinal acceleration or deceleration, and lateral steering angle control independently. Therefore, the conventional autonomous driving control method is unable to predict the future movement of the vehicle and thus causes instabilities, such as sudden braking or steering wheel shaking. These problems are aggravated, particularly, in high-speed travelling, and reduce the safety and comfort of the vehicle.

The foregoing is intended merely to aid in the understanding of the background of the present disclosure, and is not intended to mean that the present disclosure falls within the purview of the related art that is already known to those skilled in the art.

### DOCUMENT OF RELATED ART

(Patent Document 1) Korean Patent No. 10-2699269 (22 Aug. 2024)

### SUMMARY OF THE INVENTION

The present disclosure is directed to providing an autonomous driving control method that combines path planning and path tracking.

According to an embodiment of the present disclosure, there is provided an autonomous driving control method using an autonomous driving control system installed inside a vehicle and controlling the vehicle over an internal communication control network of the vehicle, the autonomous driving control method including: (A) receiving a destination and generating a path plan on the basis of an initial position of the vehicle; (B) measuring a position and a heading angle of the vehicle at a current time point when the vehicle is travelling; (C) calculating a target position and a target heading angle of the vehicle at the current time point on the basis of the path plan; (D) calculating, on the basis of the measured position and the measured heading angle of the vehicle at the current time point and the calculated target position and the calculated target heading angle of the vehicle at the current time point, a longitudinal error, a lateral error, and a heading angle error at the current time point; (E) calculating, on the basis of the calculated longitudinal error, the calculated lateral error, and the calculated heading angle error at the current time point, a required linear velocity and a required angular velocity of the vehicle that are required; and (F) controlling, on the basis of the calculated required linear velocity and the calculated required angular velocity, an acceleration pedal (or a brake) and a steering wheel of the vehicle.

In one embodiment, in step (D), the longitudinal error, the lateral error, and the heading angle may be calculated by (Equation 1) below.

$$the longitudinal error {X}_{e r r o r} = cos θ * ( {X}_{target} - X ) + sin θ * ( {Y}_{target} - Y ) \qquad ( Equation 1 )$$

$$the lateral error {Y}_{e r r o r} = - sin θ cos θ * ( {X}_{target} - X ) + cos θ * ( {Y}_{target} - Y )$$

$$the heading angle error {θ}_{error} = {θ}_{target} - θ$$

Herein, X may denote a longitudinal position of the vehicle at the current time point,
Y may denote a lateral position of the vehicle at the current time point,
θ may denote the heading angle of the vehicle at the current time point,
X_{target} may denote a target longitudinal position of the vehicle on the basis of the path plan of the vehicle at the current time point,
Y_{target} may denote a target lateral position of the vehicle on the basis of the path plan of the vehicle at the current time point, and
θ_{target} may denote the target heading angle of the vehicle on the basis of the path plan of the vehicle at the current time point.

In an embodiment, in step (E), the required linear velocity and the required angular velocity may be calculated by (Equation 2) below.

$$the required linear velocity {V}_{r e q} = {V}_{target} * cos {θ}_{e r r o r} + {K}_{X} * {X}_{e r r o r} \qquad ( Equation 2 )$$

$$the required angular velocity {ω}_{r e q} = {ω}_{target} + {V}_{target} * ( {K}_{Y} * {Y}_{e r r o r} + {K}_{θ} * sin {θ}_{e r r o r} )$$

Herein, V_{target} may denote a target linear velocity calculated on the basis of the path plan of the vehicle at the current time point,
ω_{target} may denote a target angular velocity calculated on the basis of the path plan of the vehicle at the current time point, and
K_{X}, K_{Y}, and K_{θ} may denote control gain constants that are experimentally obtained to correct the longitudinal error, the lateral error, and the heading angle error, respectively.

An autonomous driving control method according to an embodiment of the present disclosure controls a vehicle by combining path planning and path tracking, thereby achieving more stable autonomous driving of the vehicle.

It should be understood that the effects are not limited to those described above, but include all effects that can be inferred from the configurations of the disclosure in the detailed description of the present disclosure or the claims.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a usage configuration diagram of an autonomous driving control system in a vehicle according to the present disclosure;

FIG. 2 is a configuration diagram of an autonomous driving control system according to the present disclosure;

FIG. 3 is a flowchart of an autonomous driving control method according to an embodiment of the present disclosure;

FIG. 4 is a detailed flowchart of controlling an acceleration pedal (or brake) and a steering wheel of a vehicle in an autonomous driving control method according to an embodiment of the present disclosure; and

FIGS. 5A to 5C are examples of a longitudinal error, a lateral error, and a heading angle error of an autonomous driving control method according to an embodiment of the present disclosure.

### DETAILED DESCRIPTION OF THE INVENTION

Hereinafter, an embodiment of the present disclosure will be described in detail with reference to the accompanying drawings. Throughout the drawings, same or similar elements will be denoted by the same reference numeral, and a redundant description thereof will be omitted. The terms “module” and “part” for elements used herein are assigned or used interchangeably for ease of description only and are not intended to have distinct meanings or roles by themselves. In addition, in describing the present disclosure, if it is decided that a detailed description of the known art related to the present disclosure makes the subject matter of the present disclosure unclear, the detailed description will be omitted. In addition, the accompanying drawings are used to help easily understanding an embodiment of the present disclosure, and the technical idea of the present disclosure is not limited to the accompanying drawings. It should be understood that all modifications, equivalents, or substitutes in the technical idea and scope of the present disclosure are also included.

Terms “first”, “second”, etc. used herein can be used to describe various elements, but the elements are not to be construed as being limited to the terms. The terms are only used to differentiate one element from other elements.

In the present application, it is to be understood that terms such as “including”, “having”, etc. are intended to indicate the existence of the features, numbers, steps, actions, elements, parts, or combinations thereof disclosed herein, and are not intended to preclude the possibility that one or more other features, numbers, steps, actions, elements, parts, or combinations thereof may exist or may be added.

Hereinafter, an autonomous driving control method according to an embodiment of the present disclosure will be described in detail with reference to the accompanying drawings.

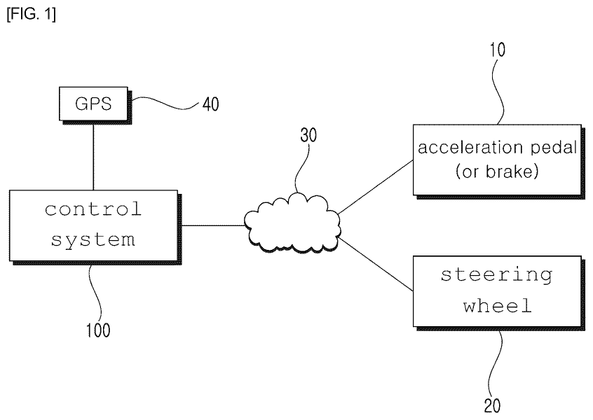

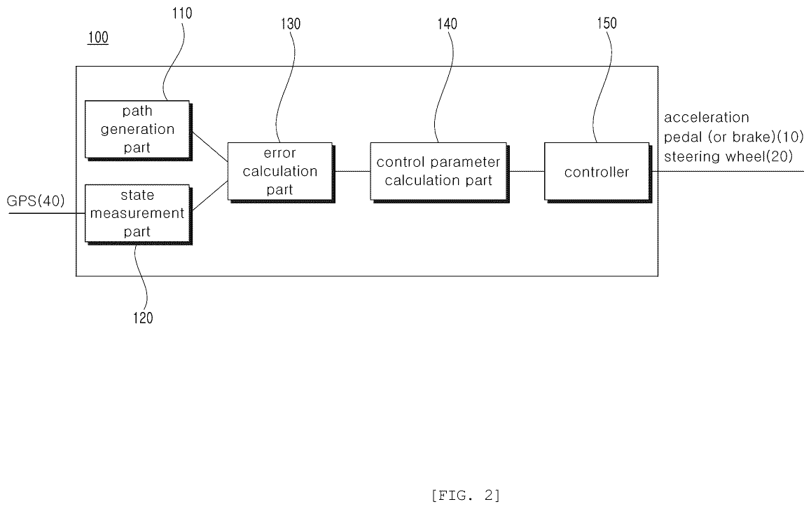

FIG. 1 is a usage configuration diagram of an autonomous driving control system in a vehicle according to the present disclosure. FIG. 2 is a configuration diagram of an autonomous driving control system according to the present disclosure.

Referring to FIG. 1, an autonomous driving control system 100 may control an acceleration pedal (or brake) 10 and a steering wheel 20 of the vehicle over an internal control communication network 30 of the vehicle, and may receive the position of the vehicle at the current time point from the Global Positioning System (GPS) 40 in order to measure the state of the vehicle at the current time point. The control system 100 may be a type of computing device or processor board that includes at least one memory and at least one central processor unit (CPU). The internal control communication network 30 of the vehicle may be a controller area network (CAN) that is used to control an engine and a transmission by receiving electronic signals from various sensors of the vehicle.

Referring to FIG. 2, the autonomous driving control system 100 of the present disclosure includes a path generation part 110, a state measurement part 120, an error calculation part 130, a control parameter calculation part 140, and a controller 150.

The path generation part 110 receives a destination from a user, and generates a path plan on the basis of the initial position of the vehicle. The path plan means data about the optimal path to take from the initial position of the vehicle to the destination input from the user. The path plan includes a target longitudinal position (X_{target}), a target lateral position (Y_{target}), a target heading angle (θ_{target}), a target linear velocity (V_{target}), and a target angular velocity (ω_{target}) for each position on the path.

The state measurement part 120 receives the position of the vehicle at the current time point from the GPS 40, and calculates the position displacement of the vehicle at the current time point to calculate the heading angle (θ) of the vehicle at the current time point. The position of the vehicle at the current time point includes the longitudinal position (X) and the lateral position (Y) of the vehicle at the current time point. The heading angle (θ) of the vehicle at the current time point means the direction angle at which the vehicle is facing. The state measurement part 120 may calculate the linear velocity (V) and the angular velocity (ω) of the vehicle at the current time point. This may be calculated from the calculated position displacement of the vehicle at the current time point.

The error calculation part 130 receives the target longitudinal position (X_{target}), the target lateral position (Y_{target}), the target heading angle (θ_{target}), the target linear velocity (V_{target}), and the target angular velocity (ω_{target}) of the vehicle at the current time point from the path generation part 110, and receives the longitudinal position (X), the lateral position (Y), and the heading angle (θ) of the vehicle at the current time point from the state measurement part 120. On the basis of these, the error calculation part 130 calculates the longitudinal error (Xₑᵣᵣₒᵣ), the lateral error (Yₑᵣᵣₒᵣ), and the heading angle error (θₑᵣᵣₒᵣ) of the vehicle at the current time point. The longitudinal error (Xₑᵣᵣₒᵣ), the lateral error (Yₑᵣᵣₒᵣ), and the heading angle error (θₑᵣᵣₒᵣ) of the vehicle at the current time point are calculated by Equation 1 below.

$$longitudinal error {X}_{e r r o r} = cos θ * ( {X}_{target} - X ) + sin θ * ( {Y}_{target} - Y ) \qquad ( Equation 1 )$$

$$lateral error {Y}_{e r r o r} = - sin θ cos θ * ( {X}_{target} - X ) + cos θ * ( {Y}_{target} - Y )$$

$$heading angle error {θ}_{error} = {θ}_{target} - θ$$

The control parameter calculation part 140 receives the calculated longitudinal error (Xₑᵣᵣₒᵣ), lateral error (Yₑᵣᵣₒᵣ), and heading angle error (θₑᵣᵣₒᵣ) of the vehicle at the current time point from the error calculation part 130 and calculates the required linear velocity (V_{req}) and the required angular velocity (ω_{req}) of the vehicle. The required linear velocity (V_{req}) and the required angular velocity (ω_{req}) mean the required velocity and angular velocity of the vehicle at the current time point in order to track the target longitudinal position (X_{target}), the target lateral position (Y_{target}), the target heading angle (θ_{target}), the target linear velocity (V_{target}), and the target angular velocity (ω_{target}) of the vehicle at the current time point. The required linear velocity (V_{req}) and the required angular velocity (ω_{req}) of the vehicle may be calculated by Equation 2 below.

$$required linear velocity {V}_{r e q} = {V}_{target} * cos {θ}_{e r r o r} + {K}_{X} * {X}_{e r r o r} \qquad ( Equation 2 )$$

$$required angular velocity {ω}_{r e q} = {ω}_{target} + {V}_{target} * ( {K}_{Y} * {Y}_{e r r o r} + {K}_{θ} * sin {θ}_{e r r o r} )$$

Herein, K_{X}, K_{Y}, and K_{θ} are control gain constants that are experimentally obtained to correct the longitudinal error, the lateral error, and the heading angle error, respectively.

From the equation, it can be seen that the required linear velocity (V_{req}) is proportional to the longitudinal error (Xₑᵣᵣₒᵣ). This means that the greater the longitudinal error (Xₑᵣᵣₒᵣ), the greater the required linear velocity (V_{req}), allowing the vehicle to track the target path faster. In addition, the required linear velocity (V_{req}) may correct the current velocity considering the heading angle error (θₑᵣᵣₒᵣ). From the equation, it can be seen that the required angular velocity (ω_{req}) is proportional to the lateral error (Yₑᵣᵣₒᵣ) and the heading angle error (ωₑᵣᵣₒᵣ). This means that the greater the lateral error (Yₑᵣᵣₒᵣ) and the heading angle error (θₑᵣᵣₒᵣ), the greater the required angular velocity (ω_{req}), allowing the vehicle to track the target path faster. Herein, the target path means the target longitudinal position (X_{target}), the target lateral position (Y_{target}), the target heading angle (θ_{target}), the target linear velocity (V_{target}), and the target angular velocity (ω_{target}) of the vehicle at the current time point calculated on the basis of the path plan.

K_{X}, K_{Y}, and K_{θ} are control gain constants that are experimentally obtained to correct the longitudinal error (Xₑᵣᵣₒᵣ), the lateral error (Yₑᵣᵣₒᵣ), and the heading angle error (θₑᵣᵣₒᵣ), respectively. K_{X}, K_{Y}, and K_{θ} mean proportionality constants for the longitudinal error (Xₑᵣᵣₒᵣ), the lateral error (Yₑᵣᵣₒᵣ), and the heading angle error (θₑᵣᵣₒᵣ), respectively, to determine how much required linear velocity (V_{req}) and required angular velocity (ω_{req}) are required so as to track the target path, and these may be experimentally obtained in various situations. For example, K_{X}, K_{Y}, and K_{θ} may be 0.2, 0.05, and 0.6, respectively.

The controller 150 receives the calculated required linear velocity (V_{req}) and required angular velocity (ω_{req}) of the vehicle from the control parameter calculation part 140, and calculates, on the basis of these, the acceleration degree and the rotation angle degree of the vehicle to control the acceleration pedal (or brake) 10 and the steering wheel 20 of the vehicle. The controller 150 forwards data about the calculated acceleration degree and rotation angle degree of the vehicle to an engine control unit (ECU) of the vehicle, and enables the ECU to control the acceleration pedal (or brake) 10 and the steering wheel 20 of the vehicle. The acceleration degree of the vehicle means the amount by which the vehicle is accelerated or decelerated (that is, acceleration), and this means the degree to which the pressure applied to the acceleration pedal (or brake) 10 is controlled. The acceleration degree of the vehicle may be proportional to the difference between the required linear velocity (V_{req}) and the linear velocity (V) of the vehicle at the current time point. The rotation angle degree of the vehicle means the degree to which the heading angle of the vehicle is turned, and this means how much the steering angle of the steering wheel 20 is controlled. The rotation angle degree (that is, steering angle) of the vehicle may be proportional to the difference between the required angular velocity (ω_{req}) and the angular velocity (ω) of the vehicle at the current time point.

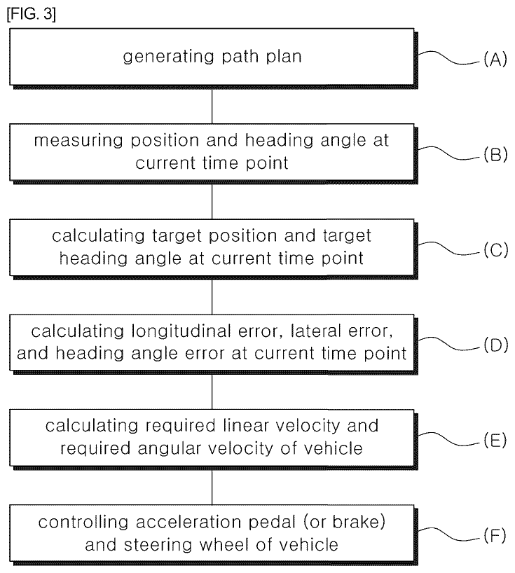

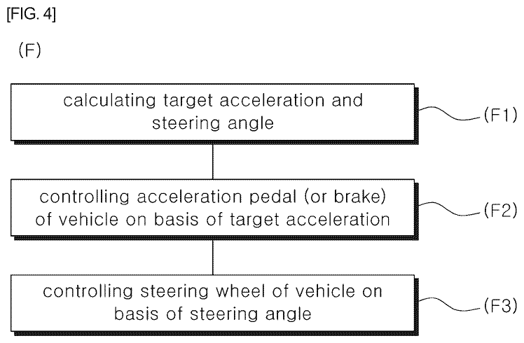

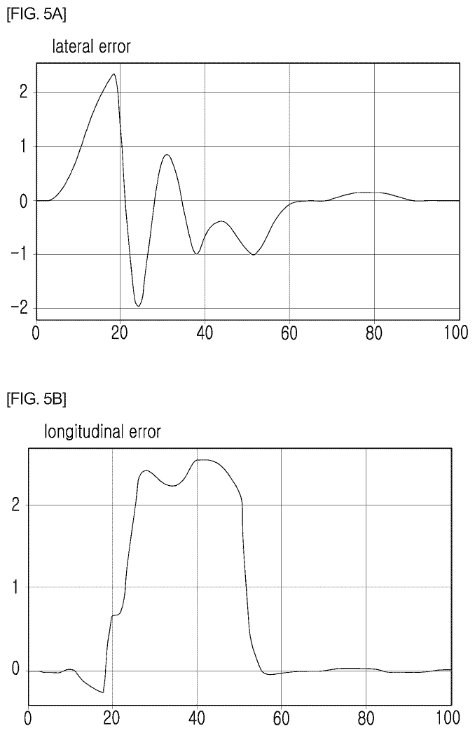

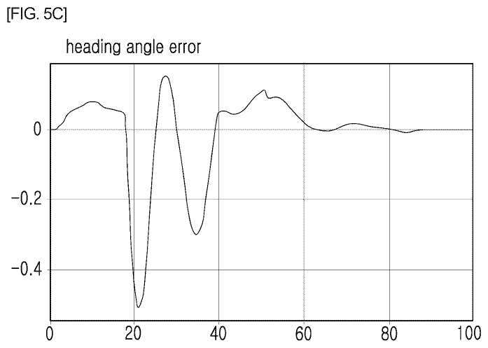

FIG. 3 is a flowchart of an autonomous driving control method according to an embodiment of the present disclosure. FIG. 4 is a detailed flowchart of controlling an acceleration pedal (or brake) and a steering wheel of a vehicle in an autonomous driving control method according to an embodiment of the present disclosure. FIGS. 5A to 5C are examples of a longitudinal error, a lateral error, and a heading angle error of an autonomous driving control method according to an embodiment of the present disclosure.

Referring to FIG. 3, an autonomous driving control method according to an embodiment of the present disclosure uses an autonomous driving control system 100 that is installed inside a vehicle and controls the vehicle over an internal communication control network of the vehicle. The autonomous driving control method includes: (A) receiving a destination and generating a path plan on the basis of an initial position of the vehicle; (B) measuring a position and a heading angle (θ) of the vehicle at a current time point when the vehicle is travelling; (C) calculating a target position and a target heading angle (θ_{target}) of the vehicle at the current time point on the basis of the path plan; (D) calculating, on the basis of the measured position and the measured heading angle (θ) of the vehicle at the current time point and the calculated target position and the calculated target heading angle (θ_{target}) of the vehicle at the current time point, a longitudinal error (Xₑᵣᵣₒᵣ), a lateral error (Yₑᵣᵣₒᵣ), and a heading angle error (θₑᵣᵣₒᵣ) at the current time point; (E) calculating, on the basis of the calculated longitudinal error (Xₑᵣᵣₒᵣ), the calculated lateral error (Yₑᵣᵣₒᵣ), and the calculated heading angle error (θₑᵣᵣₒᵣ) at the current time point, a required linear velocity (V_{req}) and a required angular velocity (ω_{req}) of the vehicle that are required; and (F) controlling, on the basis of the calculated required linear velocity (V_{req}) and the calculated required angular velocity (ω_{req}), an acceleration pedal (or a brake) 10 and a steering wheel 20 of the vehicle.

As described above, step (A) is performed by the path generation part 110. The path plan may include the target longitudinal position (X_{target}), the target lateral position (Y_{target}), the target heading angle (θ_{target}), the target linear velocity (V_{target}), and the target angular velocity (ω_{target}) for each position on the path.

As described above, step (B) is performed by the state measurement part 120. The position of the vehicle at the current time point may include the longitudinal position (X) and the lateral position (Y) of the vehicle at the current time point. In addition, in step (B), the linear velocity (V) and the angular velocity (ω) of the vehicle at the current time point may be further calculated.

As described above, step (C) is performed by the path generation part 110.

As described above, step (D) is performed by the error calculation part 130. The target longitudinal position (X_{target}), the target lateral position (Y_{target}), the target heading angle (θ_{target}), the target linear velocity (V_{target}), and the target angular velocity (ω_{target}) of the vehicle at the current time point may be received from the path generation part 110. The longitudinal position (X), the lateral position (Y), and the heading angle (θ) of the vehicle at the current time point may be received from the state measurement part 120. On the basis of these, the error calculation part 130 may calculate the longitudinal error (Xₑᵣᵣₒᵣ), the lateral error (Yₑᵣᵣₒᵣ), and the heading angle error (θₑᵣᵣₒᵣ) of the vehicle at the current time point.

As described above, step (E) is performed by the control parameter calculation part 140. Receiving the calculated longitudinal error (Xₑᵣᵣₒᵣ), lateral error (Yₑᵣᵣₒᵣ), and heading angle error (θₑᵣᵣₒᵣ) of the vehicle at the current time point from the error calculation part 130, the control parameter calculation part 140 calculates the required linear velocity (V_{req}) and the required angular velocity (ω_{req}) of the vehicle. The required linear velocity (V_{req}) and the required angular velocity (ω_{req}) mean the required velocity and angular velocity of the vehicle at the current time point in order to track the target longitudinal position (X_{target}), the target lateral position (Y_{target}), the target heading angle (ω_{target}), the target linear velocity (V_{target}), and the target angular velocity (ω_{target}) of the vehicle at the current time point.

As described above, step (F) is performed by the controller 150. The calculated required linear velocity (V_{req}) and required angular velocity (ω_{req}) of the vehicle are received from the control parameter calculation part 140. On the basis of these, the controller 150 calculates the target acceleration (a_{target}) of the vehicle and the steering angle (δ) of the steering wheel 20 to control the acceleration pedal (or brake) 10 and the steering wheel 20 of the vehicle. The controller 150 forwards data about the calculated target acceleration (a_{target}) of the vehicle and the calculated steering angle (δ) of the steering wheel 20 to the engine control unit (ECU) of the vehicle, and enables the ECU to control the acceleration pedal (or brake) 10 and the steering wheel 20 of the vehicle.

Referring to FIG. 4, step (F) may include: (F1) calculating the target acceleration (a_{target}) and the steering angle (δ); (F2) controlling the acceleration pedal (or brake) of the vehicle on the basis of the calculated target acceleration (a_{target}); and (F3) controlling the steering wheel of the vehicle on the basis of the calculated steering angle (δ).

In step (F1), how to calculate the target acceleration (a_{target}) of the vehicle and the steering angle (δ) of the steering wheel 20 is as follows.

Velocity control adjusts the linear velocity of the vehicle by calculating acceleration or deceleration so that the vehicle reaches the target linear velocity (V_{target}). To this end, on the basis of the error between the current linear velocity (V) and the target linear velocity (V_{target}) of the vehicle, the target acceleration (a_{target}) may be calculated by Equation 3 below.

$$target acceleration {a}_{target} = ( {V}_{target} - V ) / {T}_{s} \qquad ( Equation 3 )$$

Herein, Tₛ denotes the sampling period or the period of a control loop.

From the equation, it can be seen that the target acceleration (a_{target}) is proportional to the difference between the target linear velocity (V_{target}) and the current linear velocity (V). When the difference between the target linear velocity (V_{target}) and the current linear velocity (V) is a positive number, the target acceleration (a_{target}) is a positive number, indicating that acceleration is required. When the difference between the target linear velocity (V_{target}) and the current linear velocity (V) is a negative number, the target acceleration (a_{target}) is a negative number, indicating that deceleration is required. The sampling period (Tₛ) is the period at which the control loop is periodically updated. The control loop is the time taken to calculate the current linear velocity (V) and the target acceleration (a_{target}) of the vehicle and update a control signal during the sampling period (Tₛ).

The control of the angular velocity (ω) for lateral control performs a function of adjusting the steering angle (δ) of the vehicle to rotate the vehicle in the target direction. However, there are two major problems with directly using the control of the angular velocity (ω) of the vehicle. First, the required angular velocity (ω_{req}) of the vehicle in the stop state is always 0, so any control input does not change the required angular velocity (ω_{req}). Second, when starting from a stop, it is sometimes necessary to start with the steering wheel 20 already rotated. This case is impossible to be dealt with through the control that minimizes the heading angle error (θₑᵣᵣₒᵣ) of the vehicle. Therefore, in the present disclosure, the following algorithm is constructed on the basis of the curvature error (Curvₑᵣᵣₒᵣ).

The target curvature (κ_{dot}) represents the turning radius required for the vehicle to follow the target path from its current state. The target curvature (κ_{dot}) may be used to determine how quickly the steering angle needs to be adjusted when the vehicle tracks the path. The target curvature (κ_{dot}) may be calculated by Equation 4 below.

$$target curvature {κ}_{dot} = {K}_{y} * {Y}_{error} + {K}_{θ} * sin {θ}_{error} \qquad ( Equation 4 )$$

K_{y}*Yₑᵣᵣₒᵣ, which is related to the error compensation for the lateral direction, compensates for the vehicle's deviation from the path so that the vehicle is positioned back on the path. K_{θ}*sin θₑᵣᵣₒᵣ, which is related to compensation for the heading angle error (θₑᵣᵣₒᵣ), compensates for the difference between the vehicle's heading and the target heading angle (θ_{target}) so that the vehicle is correctly directed. The target curvature (κ_{dot}) indicates how quickly the steering angle of the vehicle needs to be changed on the basis of the error on the path, to keep the turning performance of the vehicle stable.

The curvature error (Curvₑᵣᵣₒᵣ) is the error in the current travelling curvature of the vehicle with respect to the target curvature (κ_{dot}) that the vehicle needs to track. The current travelling curvature of the vehicle may be the ratio of the current linear velocity (V) to the angular velocity (ω) of the vehicle. Thus, curvature error (Curvₑᵣᵣₒᵣ) may be calculated by Equation 5 below.

$$curvature error {Curv}_{error} = {κ}_{dot} - \frac{V}{ω} \qquad ( Equation 5 )$$

The steering angle (δ) to which the steering wheel 20 of the vehicle needs to be controlled on the basis of the curvature error (Curvₑᵣᵣₒᵣ) may be calculated by Equation 6 below.

$$steering angle δ = {K}_{curv} ⋆ Cur {v}_{error} + Gear ratio * {κ}_{dot} \qquad ( Equation 6 )$$

Herein, K_{curv} is a control gain constant that is experimentally obtained to correct the error in curvature.
Gear ratio is the gear ratio of the steering wheel 20 of the vehicle.

K_{curv} is a control gain constant that is experimentally obtained to correct the error in curvature (curvature error (Curvₑᵣᵣₒᵣ)). K_{curv} means a proportionality constant for the curvature error (Curvₑᵣᵣₒᵣ) to determine how much steering angle (δ) of the steering wheel 20 is required so as to track the target curvature (κ_{dot}), and this may be experimentally obtained in various situations. For example, K_{curv} may be 50.

Gear ratio is the gear ratio of the steering wheel 20 of the vehicle, and may mean the change in the heading angle of the vehicle with respect to the rotation angle of the steering wheel. The gear ratio values vary from vehicle to vehicle. For example, the gear ratio of the steering wheel 20 may be 30*180/π.

When a vehicle is controlled using an autonomous driving control method according to an embodiment of the present disclosure, referring to FIGS. 5A to 5C, it can be seen that the longitudinal error (Xₑᵣᵣₒᵣ), the lateral error (Yₑᵣᵣₒᵣ), and the heading angle error (θₑᵣᵣₒᵣ) converge to 0 as they are eliminated over time.

Although preferred embodiments of the present disclosure have been described for illustrative purposes, those skilled in the art will appreciate that various modifications, additions, and substitutions are possible, without departing from the scope and spirit of the disclosure as disclosed in the accompanying claims.

What is claimed is:

1. An autonomous driving control method using an autonomous driving control system installed inside a vehicle and controlling the vehicle over an internal communication control network of the vehicle, the autonomous driving control method comprising:
receiving a destination and generating a path plan on the basis of an initial position of the vehicle;
measuring a position and a heading angle of the vehicle at a current time point when the vehicle is travelling;
calculating a target position and a target heading angle of the vehicle at the current time point on the basis of the path plan;
calculating, on the basis of the measured position and the measured heading angle of the vehicle at the current time point and the calculated target position and the calculated target heading angle of the vehicle at the current time point, a longitudinal error, a lateral error, and a heading angle error at the current time point;
calculating, on the basis of the calculated longitudinal error, the calculated lateral error, and the calculated heading angle error at the current time point, a required linear velocity and a required angular velocity of the vehicle that are required; and
controlling, on the basis of the calculated required linear velocity and the calculated required angular velocity, an acceleration pedal (or a brake) and a steering wheel of the vehicle.

2. The autonomous driving control method of claim 1, wherein the longitudinal error, the lateral error, and the heading angle are calculated by (Equation 1)
$$the longitudinal error {X}_{e r r o r} = cos θ * ( {X}_{target} - X ) + sin θ * ( {Y}_{target} - Y ) \qquad ( Equation 1 )$$
$$the lateral error {Y}_{e r r o r} = - sin θ cos θ * ( {X}_{target} - X ) + cos θ * ( {Y}_{target} - Y )$$
$$the heading angle error {θ}_{error} = {θ}_{target} - θ$$
Herein, X denotes a longitudinal position of the vehicle at the current time point,
Y denotes a lateral position of the vehicle at the current time point,
θ denotes the heading angle of the vehicle at the current time point,
X_{target} denotes a target longitudinal position calculated on the basis of the path plan of the vehicle at the current time point,
Y_{target} denotes a target lateral position calculated on the basis of the path plan of the vehicle at the current time point, and
θ_{target} denotes the target heading angle calculated on the basis of the path plan of the vehicle at the current time point.

3. The autonomous driving control method of claim 2, wherein the required linear velocity and the required angular velocity are calculated by (Equation 2)
$$the required linear velocity {V}_{r e q} = {V}_{target} * cos {θ}_{target} + {K}_{X} * {X}_{e r r o r} \qquad ( Equation 2 )$$
$$the required angular velocity {ω}_{r e q} = {ω}_{target} + {V}_{target} * ( {K}_{Y} * {Y}_{e r r o r} + {K}_{θ} * sin {θ}_{e r r o r} )$$
herein, V_{target} denotes a target linear velocity calculated on the basis of the path plan of the vehicle at the current time point,
ω_{target} denotes a target angular velocity calculated on the basis of the path plan of the vehicle at the current time point, and
K_{X}, K_{Y}, and K_{θ} denote control gain constants that are experimentally obtained to correct the longitudinal error, the lateral error, and the heading angle error, respectively.

4. The autonomous driving control method of claim 3, wherein the controlling of the acceleration pedal (or the brake) and the steering wheel of the vehicle comprises:
calculating a target acceleration (a_{target}) and a steering angle (δ);
controlling the acceleration pedal (or the brake) of the vehicle on the basis of the calculated target acceleration (a_{target}); and
controlling the steering wheel of the vehicle on the basis of the calculated steering angle (δ),
the target acceleration (a_{target}) and the steering angle (δ) are calculated by (Equation 3) and (Equation 6), respectively
$$the target acceleration {a}_{target} = ( {V}_{target} - V ) / {T}_{s} \qquad ( Equation 3 )$$
herein, Tₛ denotes a sampling period or a period of a control loop
$$the steering angle δ = {K}_{curv} ⋆ Cur {v}_{error} + Gear ratio * {κ}_{dot} \qquad ( Equation 6 )$$
herein, K_{curv} denotes a control gain constant that is experimentally obtained to correct an error in curvature
$$the target curvature {κ}_{dot} = {K}_{y} * {Y}_{error} + {K}_{θ} * sin {θ}_{error}$$
$$the curvature error {Curv}_{erroe} = {κ}_{dot} - \frac{V}{ω}$$
the Gear ratio is a gear ratio of the steering wheel of the vehicle.
